(19) United States
(12) Patent Application Publication
(10) Pub. No.: US 2010/0069547 A1
(43) Pub. Date: Mar. 18, 2010

(54) Shape Memory Polymers Containing Degradation Accelerant

(75) Inventors: Malcolm Brown, Yorkshire (GB); Michael Hall, Middlesbrough (GB); John Rose, Collierville, TN (US); Horacio Montes de Oca Balderas, York (GB)

Correspondence Address: NORMAN F. HAINER, JR.;SMITH & NEPHEW, INC., 150 MINUTEMAN ROAD, ANDOVER, MA, 01801, US

(73) Assignee: Smith & Nephew, Inc., Andover, MA (US)

(21) Appl. No.: 12/595,529

(22) PCT Filed: Apr. 15, 2008
(86) PCT No.: PCT/US08/60325

§ 371 Date: Oct. 12, 2009

Related U.S. Application Data
(60) Provisional application No. 60/912,821, filed on Apr. 19, 2007.

(51) Int. Cl. C08K 5/09

(52) U.S. Cl. 524/300

(57) ABSTRACT

The present disclosure relates to a polymer composition including a lactic acid based polymer material and a fatty acid, wherein the polymer material includes shape memory qualities.

### CROSS-REFERENCE TO RELATED APPLICATIONS

This application is a PCT International Application of U.S. Patent Application No. 60/912,821 filed on Apr. 19, 2007, the disclosure of which is incorporated by reference in its entirety.

### BACKGROUND OF THE INVENTION

1. Field of the Invention

This present disclosure relates generally to shape memory polymers and, more particularly, shape memory polymers having degradation accelerants.

2. Related Art

Resorbable shape memory polymers have had various applications in medical devices including stents, fracture fixation devices, and tissue fasteners. Control of degradation rates of shape memory polymers is normally achieved by changing the type and/or ratio of monomer species used to produce the polymers. However, it is difficult to tailor shape memory polymers with properties for specific applications as the mechanical properties and degradation rate are interdependent, so changes to the formulation to achieve specification for one may be detrimental to the other.

There remains a need in the art for a shape memory polymer composite that maintains good mechanical properties and shape memory characteristics, while offering a tailored degradation rate once the primary role of the shape memory polymer is no longer needed.

### SUMMARY OF THE INVENTION

In one aspect, the present disclosure relates to a polymer composition including a lactic acid based polymer material and a fatty acid, wherein the polymer material includes shape memory qualities. In one embodiment, the fatty acid comprises between about 0.5% to about 10% by weight of the polymer composition. In another embodiment, the fatty acid comprises between about 2% to about 5% by weight of the polymer composition. In another embodiment, the polymer material includes Poly L,D lactic acid. In yet another embodiment, the fatty acid includes lauric acid.

Further features, aspects, and advantages of the present disclosure, as well as the structure and operation of various embodiments of the present disclosure, are described in detail below with reference to the accompanying drawings.

### BRIEF DESCRIPTION OF THE DRAWINGS

The accompanying drawing, which is incorporated in and forms a part of the specification, illustrates the embodiments of the present disclosure and together with the description, serves to explain the principles of the disclosure. In the drawing:

FIG. 1 shows the changes in molecular weight of shape memory polymers during in-vitro degradation.

### DETAILED DESCRIPTION OF THE EMBODIMENTS

The following description of the preferred embodiment(s) is merely exemplary in nature and is in no way intended to limit the disclosure, its application, or uses.

The present disclosure relates to a shape memory polymer material including a fatty acid or derivative that enables a pre-determined strength retention profile to be produced in the shape memory polymer without having to compromise its shape memory qualities, specifically its relaxation flow characteristics, or its mechanical strength.

For the purposes of this disclosure, the polymer includes a polylactide based polymer. However, any biocompatibie, resorbable, polymeric material may be used, including, without limitation, poly-alpha-hydroxy acids, polycaprolactones, polydioxanones, polyesters, polyglycolic acid, polyglycols, polylactides, polyorthoesters, polyphosphates, polyoxaesters, polyphosphoesters, polyphosphonates, polysaccharides, polytyrosine carbonates, polyurethanes, and copolymers or polymer blends thereof.

The acid or derivative may be selected from a group including hexanoic acid, octanoic acid, decanoic acid, lauric acid, myristic acid, crotonic acid, 4-pentanoic acid, 2-hexanoic acid, undecylenic acid, petroselenic acid, oleic acid, erucic acid, 2,4-hexadienoic acid, linoleic acid, linolenic acid, benzoic acid, hydrocinnamic acid, 4-isopropylbenzoic acid, ibuprofen, ricinoleic acid, adipic acid, suberic acid, phthalic acid, 2-bromolauric acid, 2,4-hydroxydodecanoic acid, monobutryrin, 2-hexyldecanoic acid, 2-butyloctanic acid, 2-ethylhexanoic acid, 2-methylvaleric acid, trans beta-hydromuconic acid, isovaleric anhydride, hexanoic anhydride, decanoic anhydride, lauric anhydride, myristic anhydride, 4-pentanoic anhydride, oleic anhydride, linoleic anhydride, benzoic anhydride, poly (azelaic anhydride), 2-octen-1-yl succinic anhydride, and phthalic anhydride.

The fatty acids or their derivatives reduce the transition temperature of the polymer material, as will be further described below. High concentrations of the fatty acid will reduce the transition temperature of the material and weaken it to a degree where the shape memory properties are compromised. For the purposes of this disclosure, a high concentration of fatty acid would be one that represents more than 10% by weight of the polymer composition. Therefore, the fatty acid concentration should between about 0.5% to about 10% by weight of the polymer composition and, in some circumstances, is between about 2% to about 5% by weight of the composition. The fatty acid concentration is dependent on the polymer and fatty acid composition used.

Generally, polymers that display shape memory qualities show a large change in modulus of elasticity at the glass transition temperature (T_{g}). The shape-memory function can be achieved by taking advantage of this characteristic. Namely, the mixture of polymer and fatty acid is processed, via processes known to one of skill in the art, to make a macroscopic body of polymer material. The body is then processed to include shape memory qualities via a process including, without limitation, zone drawing, hydrostatic extrusion, die drawing, compression flow molding, thermoforming, rolling, and roll drawing. During this process, a definite shape (the original shape) is imparted to the macroscopic body. The body may then be softened by providing it with energy to increase its temperature to a temperature (T_{f}) higher than the T_{g} of the polymer, but lower than the melting temperature (TO. At this temperature, the material may be deformed so as to form a different macroscopic shape (the deformed shape). The polymeric material is then cooled to a temperature lower than the T_{g}, while maintaining its deformed state. When the polymeric material is heated again to a temperature higher than the secondary molding temperature T_{f}, but lower than the Tₘ, the deformed state disappears and the polymeric material relaxes to recover its original shape. The glass transition temperature of the polymer material will vary based on a variety of factors, such as molecular weight, composition, structure of the polymer, and other factors known to one of ordinary skill in the art.

The macroscopic body of polymer material may include fixation devices such as, without limitation, rods, pins, nails, screws, plates, anchors, and wedges for use in repair of bone and soft tissue. In addition, the body of polymer material may include a sleeve of polymer material, including a central channel, which allows the sleeve to be placed on a fixation device, such as the fixation devices listed above, for subsequent use in fixating the fixation device to bone, as is described in PCT International Application No. PCT/US08/56828 (the '828 application), the disclosure of which is incorporated herein by reference in its entirety.

Examples of adding energy to the polymer material include electrical and thermal energy sources, the use of force, or mechanical energy, and/or a solvent. The thermal energy source may include a heated liquid, such as water or saline. It is also within the scope of this disclosure that once the macroscopic body is placed in the bone, body heat would be transferred from blood and tissue, via thermal conduction, to provide the energy necessary to deform the shape memory polymer material. In this instance, body temperature would be used as the thermal energy source. Examples of electrical energy sources include heat generating devices such as a cauterizing device or insulated conductor, as more fully described in the '828 applicatio, or a heating probe, as more fully described in PCT Application No. PCT/US2008/056836, the disclosure of which is incorporated herein by reference in its entirety.

Any suitable force that can be applied either preoperatively or intra-operatively can be used. One example includes the use of ultra sonic devices, which can relax the polymer material with minimal heat generation. Solvents that could be used include organic-based solvents and aqueous-based solvents, including body fluids. Care should be taken that the selected solvent is not contra indicated for the patient, particularly when the solvent is used intra-operatively. The choice of solvents will also be selected based upon the material to be relaxed. Examples of solvents that can be used to relax the polymer material include alcohols, glycols, glycol ethers, oils, fatty acids, acetates, acetylenes, ketones, aromatic hydrocarbon solvents, and chlorinated solvents.

The polymeric material may include a composite or matrix having reinforcing material or phases such as glass fibers, carbon fibers, polymeric fibers, ceramic fibers, ceramic particulates, rods, platelets, and fillers. Other reinforcing material or phases known to one of ordinary skill in the art may also be used. In addition, the polymeric material may be porous. Porosity may allow infiltration by cells from surrounding tissues, thereby enhancing the integration of the material to the tissue. Also, one or more active agents may be incorporated into the material, Suitable active agents include bone morphogenic proteins, antibiotics, anti-inflammatories, angiogenic factors, osteogenic factors, monobutyrin, thrombin, modified proteins, platelet rich plasma/solution, platelet poor plasma/solution, bone marrow aspirate, and any cells sourced from flora or fauna, such as living cells, preserved cells, dormant cells, and dead cells. It will be appreciated that other bioactive agents known to one of ordinary skill in the art may also be used. Preferably, the active agent is incorporated into the polymeric shape memory material, to be released during the relaxation or degradation of the polymer material. Advantageously, the incorporation of an active agent can act to combat infection at the site of implantation and/or to promote new tissue growth.

### Example

Two mixtures of 70 g of Poly (L-co-D, L-Lactide) (PLDLA) 70:30 and 1.43 g of lauric acid were placed in two 500 ml jars, one mixture in each jar. 400 ml of dichloromethane solvent was then added to each jar and the jars were placed on rollers to mix the contents until they had completely dissolved. The resulting solutions were cast into a single sheet by pouring them into a tray and allowing the solvent to evaporate overnight. The polymer sheet was vacuum dried at up to about 40° C. for two days, then ground into granules via a granulator fitted with a 3 mm aperture grating. The resulting granules were then vacuum dried at 30° C. for a further 10 days to remove any residual solvent.

Approximately 140 g of the above granules and 140 g of PLDLA granules without lauric acid, were each molded to produce two 30 mm diameter rods suitable for die drawing. The PLDLA rods not containing lauric acid were used as the control. These rods were drawn through a 15 mm die at 75° C. at a rate of 30 mm/minute to produce rods with a diameter of approximately 15 mm. The shape recovery properties of these rods were then demonstrated by placing samples of the rods in hot water (about 90° C.) for 5 minutes. The changes in diameter due to recovery are shown in Table 1. It is observed that the addition of lauric acid did not affect the shape memory properties of the rod, as both samples returned to their original diameter of 30 mm.

TABLE 1

| | Diameter (mm) | |
|---|---|---|
| Sample | Pre-recovery | Post-recovery |
| Control PLDLA SMP rod | 15 | 30 |
| PLDLA + 2% Lauric acid SMP rod | 14 | 30 |

Samples of both the control rods and the lauric acid rods were degraded in-vitro in phosphate buffered saline (PBS) at 37° C. for up to 42 weeks. Specifically, 0.35 g to 0.50 g of each sample were placed in 20 ml of PBS then put in a 37° C. incubator. At two week intervals one sample of each type was removed from the incubator and placed in the freezer to halt the degradation.

After the 42 week time point, the samples were removed from the freezer and their molecular weight distributions determined via the following process: Samples were prepared in chloroform +0.1% toluene at concentrations of approximately 1 mg/mL. The samples were allowed to dissolve over night with occasional, gentle agitation. The resultant solutions were filtered through 0.45 μm PTFE syringe filters before analysis. Molecular weight was determined by gel permeation chromatography (GPC) in chloroform using a Polymer labs Mixed-B column. Calibration was achieved using narrowly disperse polystyrene standards.

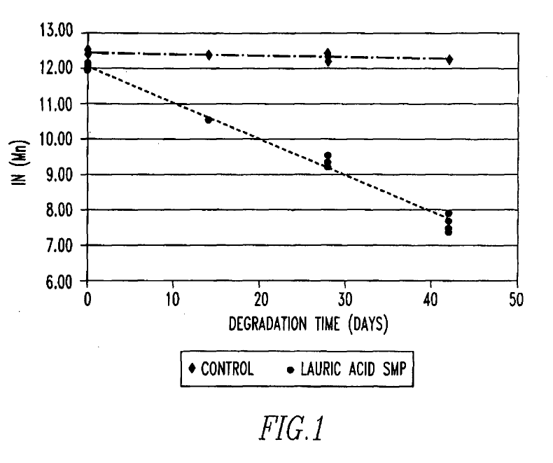

The number average molecular weights (Mn) obtained for both polymer rods are shown in FIG. 1. Only a small decline in the Mn of the control rod was observed over the 43 week degradation period. However, the Mn of the lauric acid rod fell substantially, dropping to less than 10% of its starting value after 28 days.

Hence it can be concluded that the addition of lauric acid may significantly increase the degradation rate of the polymer material, without compromising the shape memory characteristics. It is believed, especially with the low percentage of fatty acid used, that the addition of the fatty acid will also not compromise the initial mechanical stability of the polymer material.

In view of the foregoing, it will be seen that the several advantages of the disclosure are achieved and attained.

The embodiments were chosen and described in order to best explain the principles of the disclosure and its practical application to thereby enable others skilled in the art to best utilize the disclosure in various embodiments and with various modifications as are suited to the particular use contemplated.

As various modifications could be made in the constructions and methods herein described and illustrated without departing from the scope of the disclosure, it is intended that all matter contained in the foregoing description or shown in the accompanying drawings shall be interpreted as illustrative rather than limiting. Thus, the breadth and scope of the present disclosure should not be limited by any of the above-described exemplary embodiments, but should be defined only in accordance with the following claims appended hereto and their equivalents.

What is claimed is:

1. A polymer composition comprising a lactic acid based polymer material and a fatty acid, wherein the polymer material includes shape memory qualities.

2. The polymer composition of claim 1 wherein the fatty acid comprises between about 0.5% to about 10% by weight of the polymer composition.

3. The polymer composition of claim 2 wherein the fatty acid comprises between about 2% to about 5% by weight of the polymer composition.

4. The polymer composition of claim 1 wherein the polymer material includes Poly L,D lactic acid.

5. The polymer composition of claim 1 wherein the fatty acid includes lauric acid.
